(19) United States
(12) Patent Application Publication
(10) Pub. No.: US 2009/0278965 A1
(43) Pub. Date: Nov. 12, 2009

(54) HIGH-SPEED PHOTOGRAPHING APPARATUS USING PLURAL CAMERAS

(76) Inventor: Kuk-Won Ko, Seongnam-si (KR)

Correspondence Address: SHERR & VAUGHN, PLLC, 620 HERNDON PARKWAY, SUITE 320, HERNDON, VA, 20170, US

(21) Appl. No.: 12/388,318

(22) Filed: Feb. 18, 2009

(30) Foreign Application Priority Data
May 7, 2008 (KR) 10-2008-0042576

(51) Int. Cl. H04N 5/225

(52) U.S. Cl. 348/262; 348/E05.024

(57) ABSTRACT

Disclosed herein is a high-speed photographing apparatus comprising a first camera for acquiring an image of an object, a second camera for acquiring the same image as the image acquired by the first camera, reflection means for reflecting the image of the object so that the first camera and the second camera obtain the same image with respect to the object, a controller for alternately providing a photographing signal to the first camera and the second camera at a speed higher than intrinsic photographing speeds of the first camera and the second camera such that the first camera and the second camera alternately capture images of the object, and an image synthesis section for synthesizing the alternately captured images.

### BACKGROUND OF THE INVENTION

1. Field of the Invention

The present invention relates to a high-speed photographing apparatus using a plurality of cameras and, more particularly, to a high-speed photographing apparatus using a plurality of cameras, which can acquire high-speed images using low-speed cameras.

2. Background of the Related Art

With the recent development of IT technology and popularization of the Internet, people who enjoy photographing as a hobby are on the rise, and thus are increasingly interested in photographing and cameras.

Furthermore, specially photographed photos are widely used as the number of cultural contents increases. Among these specially photographed photos, momentarily captured images frequency used for advertisement or broadcasting as well as scientific technology require a specially manufactured high-speed camera. The high-speed camera that records a picture of an object within about 1/250 seconds can capture an image of a very rapidly moving object such as a free-falling object or exploding moment.

General users have difficulty in using the specially manufactured high-speed camera so that demands for high-speed photographing using a conventional camera increase.

In order to perform high-speed photographing using a conventional camera, the camera should be set to maximum shutter speed and it is difficult to obtain a desired image of a moving object even though the moving image is captured.

Specifically, it is required to open the iris of the camera and, at the same time, operate a speed flash (speed light, electronic flash) in order to photograph a rapidly moving object. However, in the case of conventional camera, it is difficult to synchronize opening of the iris and operation of the speed flash, and thus underexposure frequently occurs. Furthermore, a user cannot take a picture of the object because the object moves very fast even though synchronization of opening of the iris and operation of the speed flash is achieved.

Accordingly, there is no option but to use a method based on experience and fortuity, which continuously photographs an object using a conventional camera and selects an image from photographed images.

The aforementioned high-speed camera is widely used in the precision industrial fields such as high-precision measurement and analysis to overcome difficulties in acquiring high-speed images using the conventional mechanical camera. It is expected that the precision industrial is developed more and more according to miniaturization and lightness, and thus technical power of industrial equipment required for the precision industry should be improved.

However, the high-speed camera is expensive in terms of its characteristics, and thus only a small number of specific enterprises or corporations can use the high-speed camera and small and medium enterprises or personal users have a difficult in using the high-speed camera. Therefore, there is an urgent need for an inexpensive high-speed photographing apparatus that can be provided to consumers who require high-speed photographing.

### SUMMARY OF THE INVENTION

Accordingly, the present invention has been made in an effort to solve the above-mentioned problems occurring in the prior art, and it is a primary object of the present invention to provide a high-speed photographing apparatus capable of acquiring high-speed images, which can be captured by an expensive high-speed camera, using the existing inexpensive low-speed camera.

To accomplish the above object, according to the present invention, there is provided a high-speed photographing apparatus comprising: a first camera for acquiring an image of an object; a second camera for acquiring the same image as the image acquired by the first camera; reflection means for reflecting the image of the object so that the first camera and the second camera obtain the same image with respect to the object; a controller for alternately providing a photographing signal to the first camera and the second camera at a speed higher than intrinsic photographing speeds of the first camera and the second camera such that the first camera and the second camera alternately capture images of the object; and an image synthesis section for synthesizing the alternately captured images.

The controller may generate the photographing signal at an equal period in response to shutter signals of the first camera and the second camera, the photographing signal may be divided into a first photographing signal and a second photographing signal respectively applied to the first camera and the second camera, and the first photographing signal and the second photographing signal may be alternately applied to the first camera and the second camera to make the first camera and the second camera alternately photograph the object.

The image synthesis section may comprise a photographing signal receiving unit for receiving the first photographing signal and the second photographing signal generated by the controller, an image signal receiving unit for receiving image signals input from the first camera and the second camera, a micro control unit for controlling the image signals input from the first camera and the second camera to be alternately stored in a memory, the memory for alternately storing the image signals, and an interface for transmitting the image signals stored in the memory to an external device, wherein it is determined whether image signals input to the image signal receiving unit correspond to the first camera or the second camera according to the photographing signal and the image signals are alternately stored in the memory.

The reflection means may be a beam splitter that splits the image of the object into two.

The first camera and the second camera may be CCD cameras.

The controller may alternately provide the first photographing signal and the second photographing signal to the first camera and the second camera at predetermined intervals.

According to the present invention, a high-speed image can be acquired using a plurality of inexpensive low-speed cameras.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 illustrates a configuration of a conventional photographing apparatus;

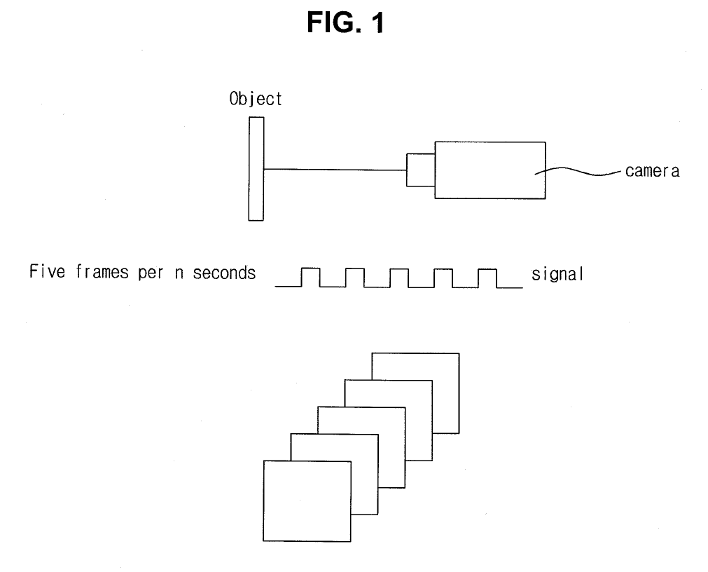

FIG. 2 illustrates a configuration of a high-speed photographing apparatus using a plurality of cameras according to the present invention;

FIG. 3 illustrates image frames acquired by the high-speed photographing apparatus using a plurality of cameras according to the present invention;

FIG. 4 is a block diagram of the high-speed photographing apparatus using a plurality of cameras according to the present invention; and

FIG. 5 illustrates a configuration of an image synthesis section illustrated in FIG. 4.

### DETAILED DESCRIPTION OF THE PREFERRED EMBODIMENT

A high-speed photographing apparatus using a plurality of cameras according to preferred embodiments of the present invention is explained with reference to attached drawings.

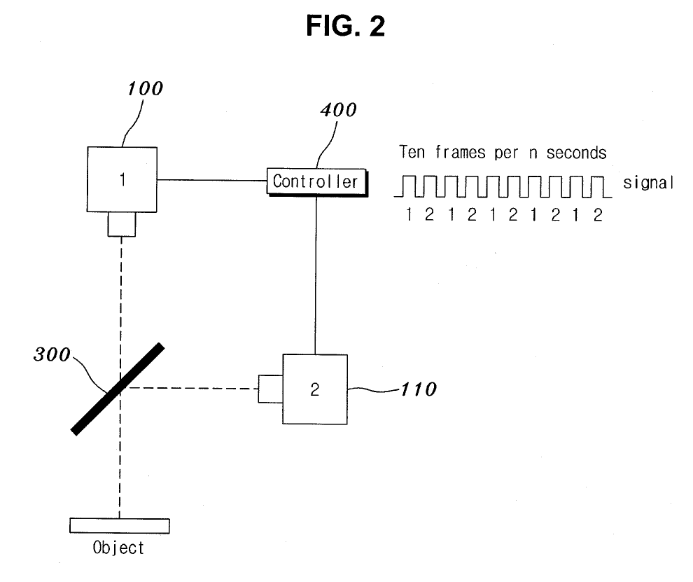

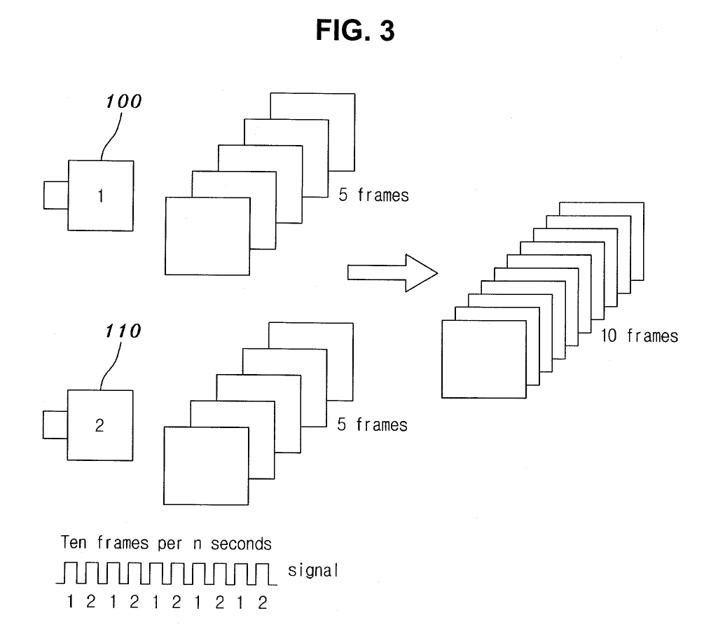

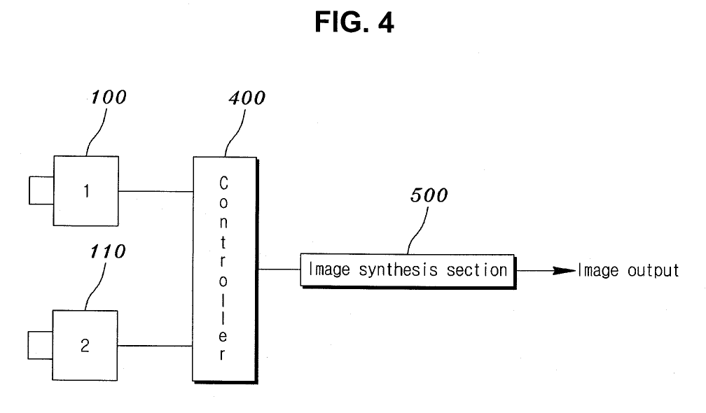

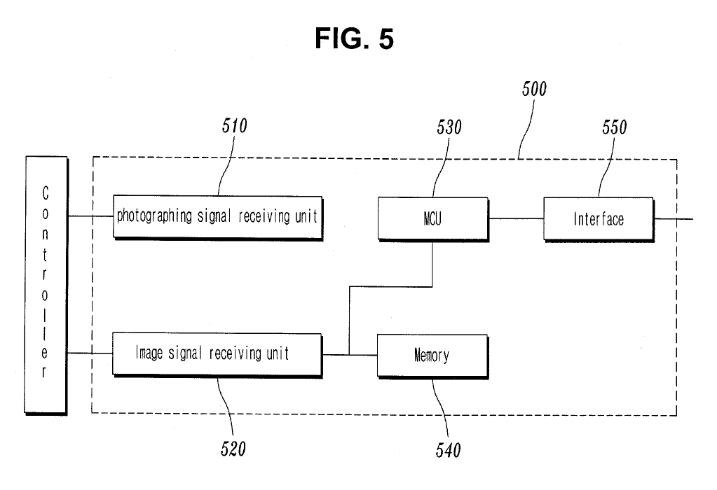

FIG. 2 illustrates a configuration of a high-speed photographing apparatus using a plurality of cameras according to the present invention, FIG. 3 illustrates image frames acquired by the high-speed photographing apparatus using a plurality of cameras according to the present invention, FIG. 4 is a block diagram of the high-speed photographing apparatus using a plurality of cameras according to the present invention, and FIG. 5 illustrates a configuration of an image synthesis section illustrated in FIG. 4.

The high-speed photographing apparatus using a plurality of cameras according to an embodiment of the present invention includes a first camera 100 for acquiring an image of an object, a second camera 110 for acquiring the same image that is obtained by the first camera 100, reflection means 300 for reflecting the image of the object such that the first camera 100 and the second camera 110 can obtain the same image, a controller 400 for alternately providing a photographing signal in response to shutter signals of the first and second cameras 100 and 110, and an image synthesis section 500 for synthesizing the images respectively acquired by the first and second cameras 100 and 110 to provide a single image.

The first camera 100 and the second camera 110 acquire the same image with respect to a single object. It is desirable that the first and second cameras 100 and 110 use a charge coupled device (CCD) camera that is a two-dimensional image sensor. The major point of the present invention is to use two cameras to take a picture of a single object so as to acquire an image at a photographing speed higher than photographing speeds of the first and second cameras using the first and second cameras.

For example, if the first camera 100 has a speed of photographing five frames per n seconds, the first camera 100 and the second camera 110 respectively take five frames of the same object for n seconds. That is, total ten frames are acquired.

Here, the first camera 100 acquires first, third, fifth, seventh and ninth frames among the ten frames and the second camera 110 acquires second, fourth, sixth, eight and tenth frames.

That is, the ten frames are acquired in such a manner that the second camera captures one frame between the first and second frames and then captures one frame between the second and third frames when the first camera captures the first, second, third, fourth and fifth frames. Accordingly, ten frames can be obtained using the two cameras for a time during which five frames can be captured.

As shown in FIG. 3, the first to tenth frames acquired by the first and second cameras are synthesized to obtain a single image.

The reflector 300 reflects the image of the object such that the first and second cameras 100 and 110 can acquire the same image. If the first camera 100 is located above the object and photographs the object, as shown in FIG. 2, the reflector 300 is located between the first camera 100 and the object and reflects the image of the object such that the second camera 110 placed opposite to the first camera can obtain the same image as that acquired by the first camera 100. The reflector 300 can use a beam splitter that splits an image of an object into two.

The controller 400 simultaneously controls the first camera 100 and the second camera 110 and provides a photographing signal at a speed higher than a maximum photographing speed of each of the two cameras. The controller 400 generates the photographing signal which controls the photographing operations of the first camera 100 and the second camera 110 in response to the shutter signals of the first camera 100 and the second camera 110.

The photographing signal is divided into a first photographing signal and a second photographing signal and output from the controller 400. The first photographing signal and the second photographing signals are alternately applied to the first camera 100 and the second camera 110. That is, the first photographing signal corresponds to even numbers if the second photographing signal corresponds to odd numbers.

In this embodiment, the controller 400 respectively provides the first photographing signal and the second photographing signal at a speed of twice the maximum photographing speed of each of the first and second cameras 100 and 110 such that the first and second cameras 100 and 110 respectively capture five frames per n seconds.

While one of the first and second cameras receives the photographing signal five times to capture five frames per n seconds, the controller 400 applies the photographing signal ten times such that the two cameras capture ten frames per n seconds. Here, the photographing signal is alternately applied to the first camera 100 and the second camera 110 to alternately photograph the object. It is desirable that the controller provides the photographing signal to the first and second cameras at an equal period such that the first and second cameras capture frames at an equal interval.

Accordingly, the first and second cameras alternately photograph the single object although they respectively capture five frames of the object, and thus it is possible to obtain an image at a speed twice the speed of capturing an image using a single camera.

Although two cameras alternately photograph an object at a photographing speed of twice the photographing speed of a single camera to obtain an image in this embodiment, three or four cameras can be used to acquire an image at a photographing speed of three times or four times the photographing speed of the single camera. In this case, the controller 400 respectively applies as many photographing signals as the number of cameras to the cameras to acquire images from the respective cameras.

The image synthesis section 500 synthesizes the image frames acquired by the first and second cameras 100 and 110 to provide a single image.

That is, the image synthesis section 500 synthesizes images obtained by alternately photographing the object into a single image. Specifically, the image synthesis section 500 synthesizes the first, third, fifth, seventh and ninth frames acquired by the first camera and the second, fourth, sixth, eighth and tens frames acquired by the second camera in the order of first to tens frames and outputs a single image.

Referring to FIG. 5, the image synthesis section 500 includes a photographing signal receiving unit 510 for receiving the photographing signal from the controller 400, an image signal receiving unit 520 for receiving image signals acquired by the first and second cameras, a micro control unit (MCU) 530 for controlling the image signals input through the image signal receiving unit 520 to be alternately stored in a memory 540, and an interface 550 for transmitting the image signals alternately stored in the memory 540 to an external device.

The photographing signal receiving unit 510 receives the first photographing signal and the second photographing signal respectively provided to the first camera and the second camera through the controller 400, and the image signal receiving unit 510 receives the image signals acquired by the first and second cameras according to the first and second photographing signals.

The micro control unit 530 stores the image signals acquired by the first and second cameras in the memory 540. Here, the micro control unit 530 checks whether the image signals are acquired by the first camera or the second camera. The stored image signals are transmitted through the interface 550 to be output as a high-speed image acquired by using the first and second cameras.

As described above, the present invention can acquire frames in great numbers larger than the number of frames, which are acquired by a single low-speed camera for a predetermined time, using a plurality of low-speed cameras. Accordingly, a high-speed image can be obtained using inexpensive low-speed cameras.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1-6. (canceled)

7. A high-speed photographing apparatus using plural cameras, the high-speed photographing apparatus comprising:
a first camera for acquiring an image of an object;
a second camera for acquiring the same image as the image acquired by the first camera;
reflection means for reflecting the image of the object so that the first camera and the second camera obtain the same image with respect to the object;
a controller for alternately providing a photographing signal to the first camera and the second camera at a speed higher than intrinsic photographing speeds of the first camera and the second camera such that the first camera and the second camera alternately capture images of the object; and
an image synthesis section for synthesizing the alternately captured images.

8. The high-speed photographing apparatus according to claim 7, wherein the controller generates the photographing signal at an equal period in response to shutter signals of the first camera and the second camera, the photographing signal is divided into a first photographing signal and a second photographing signal respectively applied to the first camera and the second camera, and the first photographing signal and the second photographing signal are alternately applied to the first camera and the second camera to make the first camera and the second camera alternately photograph the object.

9. The high-speed photographing apparatus according to claim 7, wherein the image synthesis section comprises:
a photographing signal receiving unit for receiving the first photographing signal and the second photographing signal generated by the controller;
an image signal receiving unit for receiving image signals from the first camera and the second camera;
a memory for storing the image signals;
a micro control unit for controlling the image signals from the first camera and the second camera to be alternately stored in the memory; and
an interface for transmitting the image signals stored in the memory to an external device,
wherein it is determined whether image signals input to the image signal receiving unit correspond to the first camera or the second camera according to the photographing signal and the image signals are alternately stored in the memory.

10. The high-speed photographing apparatus according to claim 7, wherein the reflection means is a beam splitter that splits the image of the object into two.

11. The high-speed photographing apparatus according to claim 7, wherein the first camera and the second camera are charge-coupled device cameras.

12. The high-speed photographing apparatus according to claim 7, wherein the controller alternately provides the first photographing signal and the second photographing signal to the first camera and the second camera at predetermined intervals.

13. The high-speed photographing apparatus according to claim 8, wherein the controller alternately provides the first photographing signal and the second photographing signal to the first camera and the second camera at predetermined intervals.
